(19) United States
(12) Patent Application Publication
(10) Pub. No.: US 2022/0281482 A1
(43) Pub. Date: Sep. 8, 2022

(54) VEHICLE CONTROL DEVICE, VEHICLE CONTROL METHOD, AND COMPUTER-READABLE STORAGE MEDIUM STORING PROGRAM

(71) Applicant: HONDA MOTOR CO., LTD., Tokyo (JP)

(72) Inventor: Taku YAMAZAKI, Tokyo (JP)

(21) Appl. No.: 17/673,208

(22) Filed: Feb. 16, 2022

(30) Foreign Application Priority Data
Mar. 3, 2021 (JP) 2021-033705

(51) Int. Cl. B60W 60/00

(52) U.S. Cl. CPC B60W 60/0027; B60W 2552/05; B60W 30/18159

(57) ABSTRACT

A vehicle control device acquires information indicating a traveling situation of a self-vehicle; estimates a future path of the self-vehicle based on the information indicating the traveling situation of the self-vehicle; acquires information indicating a traveling situation of another vehicle; estimates a future path of the other vehicle based on the information indicating the traveling situation of the other vehicle; determines whether or not to execute driving support based on a position change of an intersection between the estimated future path of the self-vehicle and the estimated future path of the other vehicle; and executes the driving support when it is determined to execute the driving support.

### CROSS-REFERENCE TO RELATED APPLICATION(S)

This application claims priority to and the benefit of Japanese Patent Application No. 2021-33705 filed on Mar. 3, 2021, the entire disclosure of which is incorporated herein by reference.

### BACKGROUND OF THE INVENTION

### Field of the Invention

The present invention relates to a vehicle control device that controls a vehicle, a vehicle control method, and a computer-readable storage medium storing a program.

### Description of the Related Art

Japanese Patent Laid-Open No. 2017-91502 describes that, in processing for performing driving support based on a possibility of collision between vehicles, a determination region is set based on an intersection X when there is an intersection X between a self-vehicle prediction path and a surrounding vehicle prediction path, and it is determined whether or not there is a crossroad node within the determination region. Japanese Patent Laid-Open No. 2017-91502 describes that a straight line extending in a direction of an absolute orientation with a current position of a self-vehicle serving as a base point is set as a self-vehicle prediction path, and a straight line extending in a direction of an absolute orientation with a current position of a surrounding vehicle serving as a base point is set as a surrounding vehicle prediction path.

### SUMMARY OF THE INVENTION

The present invention provides a vehicle control device, a vehicle control method, and a computer-readable storage medium storing a program for appropriately performing driving support based on a possibility of collision between vehicles.

The present invention in its first aspect provides a vehicle control device comprising: a first acquisition unit configured to acquire information indicating a traveling situation of a self-vehicle; a first estimation unit configured to estimate a future path of the self-vehicle based on the information indicating the traveling situation of the self-vehicle acquired by the first acquisition unit; a second acquisition unit configured to acquire information indicating a traveling situation of another vehicle that is different from the self-vehicle; a second estimation unit configured to estimate a future path of the other vehicle based on the information indicating the traveling situation of the other vehicle acquired by the second acquisition unit; a determination unit configured to determine whether or not to execute driving support based on a position change of an intersection between the future path of the self-vehicle estimated by the first estimation unit and the future path of the other vehicle estimated by the second estimation unit; and an execution unit configured to execute the driving support when the determination unit determines to execute the driving support.

The present invention in its second aspect provides a vehicle control method executed in a vehicle control device, the vehicle control method comprising: acquiring information indicating a traveling situation of a self-vehicle; estimating a future path of the self-vehicle based on the acquired information indicating the traveling situation of the self-vehicle; acquiring information indicating a traveling situation of another vehicle different from the self-vehicle; estimating a future path of the other vehicle based on the acquired information indicating the traveling situation of the other vehicle; determining whether or not to execute driving support based on a position change of an intersection between the estimated future path of the self-vehicle and the estimated future path of the other vehicle; and executing the driving support when it is determined to execute the driving support.

The present invention in its third aspect provides a non-transitory computer-readable storage medium storing a program that causes a computer to perform the functions of: acquiring information indicating a traveling situation of a self-vehicle; estimating a future path of the self-vehicle based on the information indicating the traveling situation of the self-vehicle; acquiring information indicating a traveling situation of another vehicle different from the self-vehicle; estimating a future path of the other vehicle based on the information indicating the traveling situation of the other vehicle; determining whether or not to execute driving support based on a position change of an intersection between the future path of the self-vehicle and the future path of the other vehicle; and executing the driving support when it is determined to execute the driving support.

According to the present invention, it is possible to appropriately perform driving support based on the possibility of collision between the vehicles.

### BRIEF DESCRIPTION OF THE DRAWINGS

FIG. 1 is a diagram illustrating a configuration of a vehicle control device;

FIG. 2 is a diagram illustrating a function block of a control unit;

FIG. 3 is a view for describing processing of driving support;

FIG. 4 is a flowchart illustrating control processing of driving support;

FIG. 5 is a flowchart illustrating control processing of driving support;

FIG. 6 is a flowchart illustrating control processing of driving support;

FIG. 7 is a flowchart illustrating control processing of driving support;

FIGS. 8A and 8B are views for describing a case where it is determined that an intersection moves away from a self-vehicle;

FIG. 9 is a flowchart illustrating control processing of driving support;

FIG. 10 is a flowchart illustrating control processing of driving support;

FIG. 11 is a view for describing priority giving;

FIG. 12 is a view for describing priority giving;

FIG. 13 is a flowchart illustrating control processing of driving support;

FIG. 14 is a view for describing processing for determining a target of control processing of driving support;

FIG. 15 is a flowchart illustrating processing for determining a target of control processing of driving support;

FIGS. 16A and 16B are views for describing processing of driving support; and

FIGS. 17A and 17B are views for describing processing of driving support.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

A shape of a road entering a crossroads is not limited to a straight line, and there may be a shape that connects to the crossroads with a curve. Even in such a case, it is necessary to appropriately perform driving support based on a possibility of collision between vehicles.

### First Embodiment

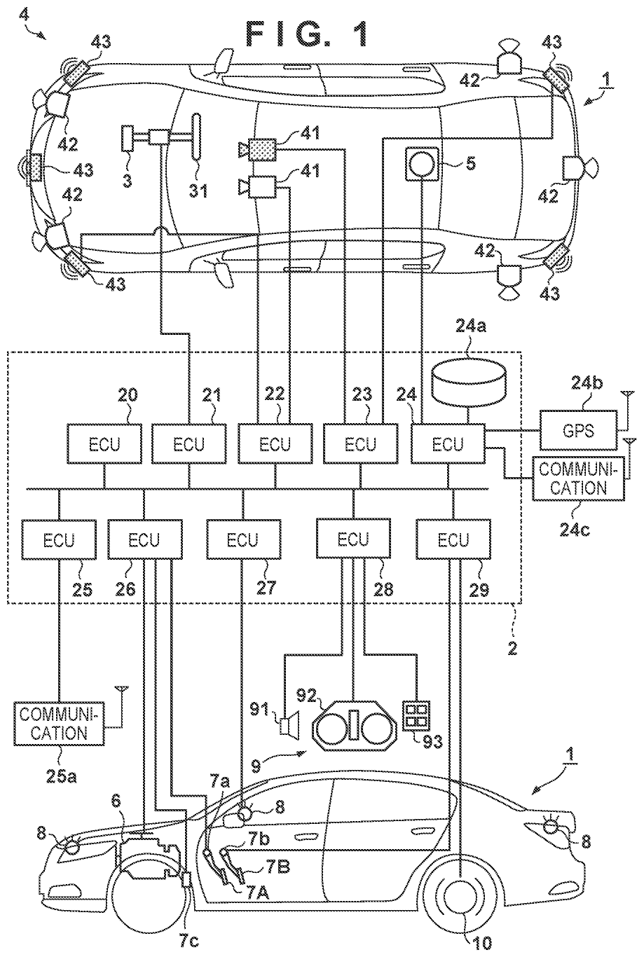

FIG. 1 is a block diagram of a vehicle control device (traveling control device) according to an embodiment of the present invention, and the vehicle control device controls a vehicle 1. In FIG. 1, the vehicle 1 is schematically illustrated in a plan view and in a side view. The vehicle 1 is, for example, a four-wheeled passenger vehicle of a sedan type.

The control device of FIG. 1 includes a control unit 2. The control unit 2 includes a plurality of ECUs 20 to 29, which are communicably connected with one another through an in-vehicle network. Each ECU includes a processor represented by a CPU, a storage device such as a semiconductor memory, an interface with an external device, and the like. The storage device stores programs executed by the processor, data used for processing by the processor, and the like. Each ECU may include a plurality of processors, storage devices, interfaces, and the like. In addition, a configuration of the control device of FIG. 1 can be a computer that implements an invention according to the program.

Hereinafter, functions and the like assigned to each of the ECUs 20 to 29 will be described. Note that the number of ECUs and the functions assigned to the ECUs may be designed as appropriate, and may be subdivided or integrated, when compared with the present embodiment.

The ECU 20 executes control related to automated driving of the vehicle 1. In automated driving, at least one of the steering and acceleration/deceleration of the vehicle 1 is automatically controlled. In a control example to be described later, both the steering and the acceleration or deceleration are automatically controlled. In the present embodiment, a description will be given on the assumption that the vehicle 1 can perform automated driving, but the operation of the present embodiment is not limited to automated driving. In addition, in the present embodiment, the term “automated driving” includes not only control in which a driver is not involved in traveling of the vehicle 1 at all but also control that partially automates traveling of the vehicle 1 and driving support for the driver.

The ECU 21 controls an electric power steering device 3. The electric power steering device 3 includes a mechanism that steers front wheels in response to the driver's driving operation (steering operation) on a steering wheel 31. In addition, the electric power steering device 3 includes a motor that exerts a driving force for assisting in steering operation or automatically steering the front wheels, and a sensor that detects a steering angle. When the driving state of the vehicle 1 is automated driving, the ECU 21 automatically controls the electric power steering device 3 in response to an instruction from the ECU 20 and controls an advancing direction of the vehicle 1.

The ECUs 22 and 23 control detection units 41 to 43 that detect the surrounding situation of the vehicle, and perform information processing on detection results. The detection unit 41 (hereinafter, it may be referred to as a camera 41) is a camera that captures an image of the front of the vehicle 1 and is attached to the vehicle interior side of a windshield at the front of a roof of the vehicle 1 in the present embodiment. By analyzing the image that has been captured by the camera 41, it is possible to extract a contour of a target or extract a division line (white line or the like) of a lane on a road.

The detection unit 42 is light detection and ranging (LIDAR), detects a target around the vehicle 1 and measures a distance to the target. In the present embodiment, five detection units 42 are provided, including one at each corner portion of the front of the vehicle 1, one at the center of the rear of the vehicle 1, and one at each lateral side of the rear of the vehicle 1. The detection unit 43 (hereinafter, it may be referred to as a radar 43) is a millimeter-wave radar, detects a target around the vehicle 1, and measures a distance to the target. In the present embodiment, five radars 43 are provided, including one at the center of the front part of the vehicle 1, one at each corner portion of the front part of the vehicle 1, and one at each corner portion of the rear part of the vehicle 1.

The ECU 22 controls one camera 41 and each detection unit 42, and performs information processing on detection results. The ECU 23 controls the other camera 41 and each radar 43, and performs information processing on detection results. Since two sets of devices for detecting the surrounding situation of the vehicle are provided, the reliability of the detection results can be improved, and since different types of detection units, such as the cameras and the radars are provided, the surrounding environment of the vehicle can be analyzed in multiple ways.

The ECU 24 controls a gyro sensor 5, a global positioning system (GPS) sensor 24b, and a communication device 24c, and performs information processing on detection results or communication results. The gyro sensor 5 detects a rotational motion of the vehicle 1. The course of the vehicle 1 can be determined based on the detection results of the gyro sensor 5, the wheel speed, and the like. The GPS sensor 24b detects the current location (for example, latitude and longitude) of the vehicle 1. The communication device 24c wirelessly communicates with a server that provides map information, traffic information, and weather information, and acquires these pieces of information. The ECU 24 can access a database 24a constructed in the storage device. The database 24a is, for example, a database of map information, and the ECU 24 performs route search from the current position to a destination and the like. In addition, in the present embodiment, the database 24a includes a database in which speed information and time information of the vehicle 1 or another vehicle are stored in association with each other. Furthermore, a database of the above-described traffic information, weather information, and the like may be constructed as the database 24a.

The ECU 25 includes a communication device 25a for vehicle-to-vehicle communication and road-to-vehicle communication. The communication device 25a wirelessly communicates with other surrounding vehicles to exchange information between the vehicles. The communication device 25a has various communication functions, and, for example, has Dedicated Short Range Communications (DSRC) function and a cellular communication function. The communication device 25a may be configured as a telematics communication unit (TCU) including a transmission/reception antenna. DSRC are a unidirectional or bidirectional short-range to mid-range communication function, and enables high-speed data communication between vehicles and between the road and the vehicle.

The ECU 26 controls a power plant 6. The power plant 6 is a mechanism that outputs driving force for rotating driving wheels of the vehicle 1, and includes, for example, an engine and a transmission. The ECU 26, for example, controls the output of the engine in response to the driver's driving operation (accelerator operation or acceleration operation) detected by an operation detection sensor 7a provided on an accelerator pedal 7A, and switches the gear ratio of the transmission based on information regarding a vehicle speed detected by a vehicle speed sensor 7c. When the driving state of the vehicle 1 is automated driving, the ECU 26 automatically controls the power plant 6 in response to an instruction from the ECU 20 and controls the acceleration and deceleration of the vehicle 1.

The ECU 27 controls a light device (headlight, taillight, and the like) including a direction indicator 8 (blinker). In the example of FIG. 1, the direction indicator 8 is provided at the front part, the door mirror, and the rear part of the vehicle 1.

The ECU 28 controls an input/output device 9. The input/output device 9 outputs information to the driver and receives an input of information from the driver. A voice output device 91 notifies the driver of information by voice. A display device 92 notifies the driver of information by displaying an image. The display device 92 is arranged, for example, in front of a driver's seat and constitutes an instrument panel or the like. Note that, although voice and display are shown here as examples, information may also be reported by vibration or light. In addition, notification of information may be provided by using a combination of some of voice, display, vibration, and light. Furthermore, the combination or the notification mode may vary depending on the level (for example, the degree of urgency) of information that should be reported. The display device 92 includes a navigation device.

An input device 93 is a group of switches that are arranged in a position where the driver can operate the switches and that are used to give instructions to the vehicle 1, and may include a voice input device.

The ECU 29 controls a brake device 10 and a parking brake (not illustrated). The brake device 10 is, for example, a disc brake device, and is provided on each wheel of the vehicle 1 to decelerate or stop the vehicle 1 by applying resistance to the rotation of the wheel. The ECU 29 controls the operation of the brake device 10, for example, in response to the driver's driving operation (braking operation) detected by an operation detection sensor 7b provided on a brake pedal 7B. When the driving state of the vehicle 1 is automated driving, the ECU 29 automatically controls the brake device 10 in response to an instruction from the ECU 20 and controls the deceleration and stop of the vehicle 1. The brake device 10 and the parking brake can also be operated to maintain a stopped state of the vehicle 1. In addition, when the transmission of the power plant 6 includes a parking lock mechanism, the parking lock mechanism can also be operated to maintain the stopped state of the vehicle 1.

Control related to automated driving of the vehicle 1 executed by the ECU 20 will be described. When instructions on a destination and automated driving are given by the driver, the ECU 20 automatically controls traveling of the vehicle 1 toward the destination according to a guidance route searched by the ECU 24. During automatic control, the ECU 20 acquires information (external environment information) regarding the surrounding situation of the vehicle 1 from the ECUs 22 and 23, and instructs the ECU 21, the ECUs 26 and 29 based on the acquired information to control steering and acceleration/deceleration of the vehicle 1. The information regarding the surrounding situation of the vehicle 1 includes, for example, other vehicles, pedestrians, public facilities such as signs and signals, and the like.

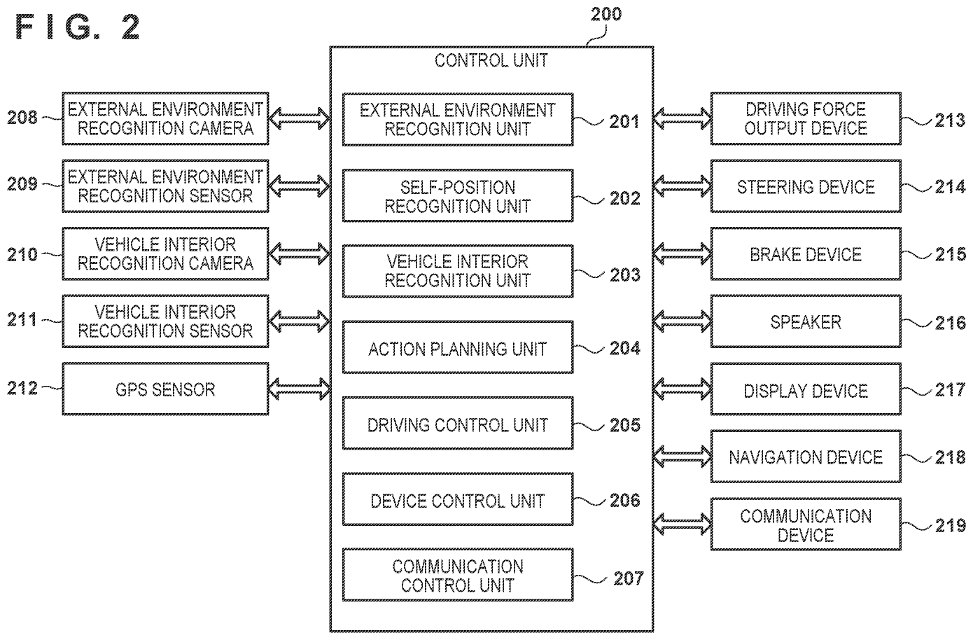

FIG. 2 is a diagram illustrating a function block of the control unit 2. A controller 200 corresponds to the control unit 2 in FIG. 1, and includes an external environment recognition unit 201, a self-position recognition unit 202, a vehicle interior recognition unit 203, an action planning unit 204, a driving control unit 205, a device control unit 206, and a communication control unit 207. Each block is realized by one ECU or a plurality of ECUs illustrated in FIG. 1.

The external environment recognition unit 201 recognizes external environment information of the vehicle 1 by image recognition or signal analysis based on signals from an external environment recognition camera 208 and an external environment recognition sensor 209. Here, the external environment recognition camera 208 is, for example, the camera 41 in FIG. 1, and the external environment recognition sensor 209 is, for example, the detection unit 42 or 43 in FIG. 1. The external environment recognition unit 201 recognizes, for example, scenes such as a crossroads, a railroad crossing, and a tunnel, a free space such as a road shoulder, and a behavior (speed and traveling direction) of other vehicles based on the signals from the external environment recognition camera 208 and the external environment recognition sensor 209. The self-position recognition unit 202 recognizes the current position of the vehicle 1 based on a signal from a GPS sensor 212. Here, the GPS sensor 212 corresponds to, for example, the GPS sensor 24b in FIG. 1.

The vehicle interior recognition unit 203 identifies an occupant of the vehicle 1 and recognizes a state of the occupant based on signals from a vehicle interior recognition camera 210 and a vehicle interior recognition sensor 211. The vehicle interior recognition camera 210 is, for example, a near-infrared camera installed on the display device 92 in the interior of the vehicle 1, and detects, for example, a direction of the line of sight of the occupant. In addition, the vehicle interior recognition sensor 211 is, for example, a sensor that detects a biological signal of the occupant. The vehicle interior recognition unit 203 recognizes that the occupant is in a dozing state, a state of working other than driving, and the like, based on these signals.

The action planning unit 204 plans an action of the vehicle 1 such as an optimal route and a risk avoidance route based on results of recognition by the external environment recognition unit 201 and the self-position recognition unit 202. The action planning unit 204 performs action planning, for example, in accordance with an entry determination based on a start point or an end point of a crossroads, a railroad crossing, or the like, and with a behavior prediction of other vehicles. The driving control unit 205 controls a driving force output device 213, a steering device 214, and a brake device 215 based on an action plan by the action planning unit 204. Here, the driving force output device 213 corresponds to the power plant 6 in FIG. 1, the steering device 214 corresponds to the electric power steering device 3 in FIG. 1, and the brake device 215 corresponds to the brake device 10, for example.

The device control unit 206 controls a device connected to the controller 200. For example, the device control unit 206 controls a speaker 216 to output a predetermined voice message such as a warning or a message for navigation. In addition, for example, the device control unit 206 causes a display device 217 to display a predetermined interface screen. The display device 217 corresponds to, for example, the display device 92. In addition, for example, the device control unit 206 controls a navigation device 218 to acquire setting information in the navigation device 218.

The communication control unit 207 generates communication data according to various communication protocols, and performs vehicle-to-vehicle communication and road-to-vehicle communication by transmitting and receiving the communication data via a communication device 219. As a communication method, DSRC are used, for example. By using DSRC, the communication control unit 207 functions as a DSRC in-vehicle device and can perform vehicle-to-vehicle communication with a communication system using other DSRC and road-to-vehicle communication with roadside equipment (RSE). In addition, the communication control unit 207 can also communicate with a portable terminal supporting DSRC. A communication protocol for DSRC includes a physical layer, a data link layer, and an application layer among seven layers of open system interconnection (OSI), and communication data is generated in at least one of the layers. In addition, as another communication method, cellular communication is used, for example. By using cellular communication, the communication control unit 207 functions as an in-vehicle device for cellular communication, and can perform vehicle-to-vehicle communication with a communication system using another cellular line and road-to-vehicle communication with roadside equipment (RSE). In addition, a communication protocol for cellular communication includes a physical layer, a data link layer, and an application layer among seven layers of open system interconnection (OSI), and communication data is generated in at least one of the layers.

The controller 200 may appropriately include a function block other than those illustrated in FIG. 2, and may include, for example, an optimal route calculation unit that calculates an optimal route to a destination based on map information acquired via the communication device 24c. In addition, the controller 200 may acquire information from a device other than the camera and the sensor illustrated in FIG. 2, and for example, may acquire information on other vehicles via the communication device 25a. Furthermore, the controller 200 receives a detection signal from not only the GPS sensor 212 but also various sensors provided on the vehicle 1. For example, the controller 200 receives a detection signal of a door opening/closing sensor and a door lock mechanism sensor provided on a door portion of the vehicle 1 via an ECU configured on the door portion. This allows the controller 200 to detect unlocking of the door and opening/closing operation of the door.

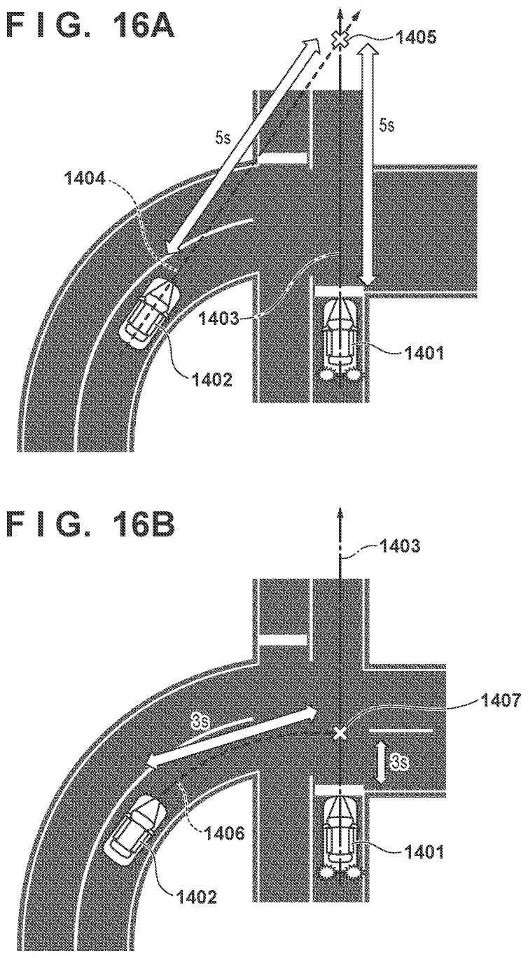

Hereinafter, the operation of the present embodiment will be described. FIGS. 16A and 16B are views illustrating a state in which a self-vehicle 1401 stops at a stop line of a crossroads and another vehicle 1402 is about to enter the crossroads along a curved road. In the case illustrated in FIGS. 16A and 16B, driving support is performed for a driver of the self-vehicle 1401, for example, based on a possibility of collision between the self-vehicle 1401 and the other vehicle 1402. Driving support includes, for example, a notification to the driver, steering control for emergency avoidance, and braking control. Hereinafter, the notification to the driver will be described as an example of driving support, but the operation of the present embodiment is similarly applicable to other controls. The notification to the driver includes message, image display, and voice output to the driver.

To determine the timing to notify the driver, processing for deriving an intersection using a future path estimated based on the current position of the self-vehicle 1401 and a future path estimated based on the current position of the other vehicle 1402 is performed. Here, when the time until the self-vehicle 1401 and the other vehicle 1402 reach the intersection is equal to or less than the threshold, it is determined that the possibility of collision is high, and the notification to the driver is performed. Here, as the time until the intersection is reached, a time to collision (TTC) is used, for example.

When the road connecting to the crossroads has a curved shape as illustrated in FIG. 16A, the following problem is assumed. A path 1403 is a future path estimated with the current position of the self-vehicle 1401 serving as a base point. That is, the path 1403 is a straight line extending along the road on which the self-vehicle 1401 travels. On the other hand, a path estimated based on the current position of the other vehicle 1402 traveling along the curved road is a straight line in the tangential direction of the curved road. That is, the path is estimated as a path 1404 that is not along the road. As a result, an intersection 1405 between the path 1403 and the path 1404 is derived as a position deviated from the crossroads, as illustrated in FIG. 16A. In addition, for example, if the time until the self-vehicle 1401 reaches the intersection 1405 after starting is calculated as 5 seconds, and the time until the other vehicle 1402 reaches the intersection 1405 is calculated as 5 seconds, and these seconds are determined to be greater than a threshold (for example, 4 seconds), then the possibility of collision is determined to be low, and the notification to the driver is not performed.

FIG. 16B illustrates an actual path, a path obtained from traveling of the other vehicle 1402 is actually a path 1406, and a point 1407 is a point having a possibility of collision. In this case, for example, if the time until the self-vehicle 1401 reaches the point 1407 after starting from a stopped state is 3 seconds, and the time until the other vehicle 1402 reaches the point 1407 is 3 seconds, then it is desirable to determine that these seconds are equal to or less than the threshold and the possibility of collision is high and to appropriately perform a notification to the driver. However, as illustrated in FIG. 16A, since the possibility of collision is determined to be low, the notification to the driver is not performed. In addition, processing for estimating the actual path 1406 becomes more complicated than processing for estimating the path 1404 of the straight line.

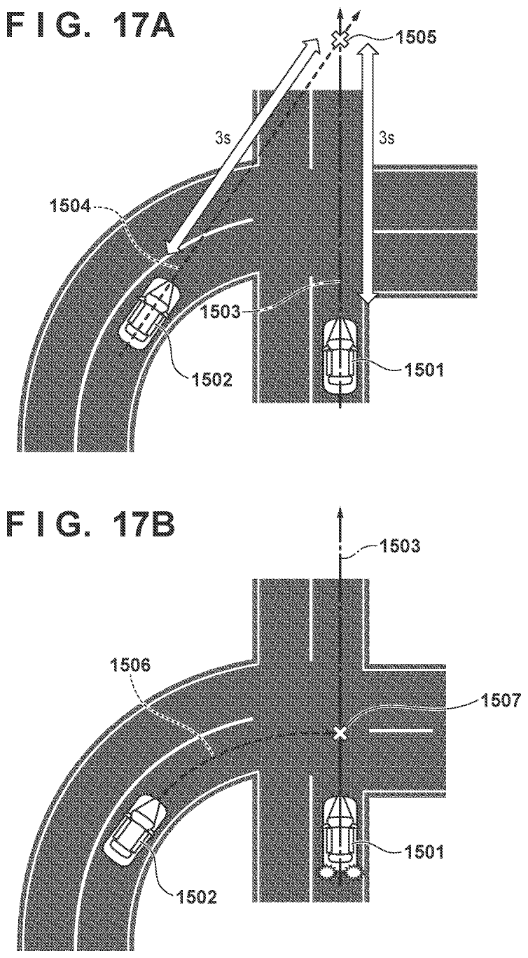

FIGS. 17A and 17B are views illustrating a state in which a self-vehicle 1501 is traveling to pass the crossroads and another vehicle 1502 is about to enter the crossroads along a curved road. In the case illustrated in FIGS. 17A and 17B, as in FIGS. 16A and 16B, a notification to the driver of the self-vehicle 1501 is performed based on a possibility of collision between the self-vehicle 1501 and the other vehicle 1502.

A path 1503 is a straight line extending along the road on which the self-vehicle 1501 travels, as in the path 1403. On the other hand, a future path estimated based on the current position of a path of the other vehicle 1502 traveling along the curved road is a straight line in the tangential direction of the curved road. That is, the path is estimated as a path 1504 that is not along the road. As a result, an intersection 1505 between the path 1503 and the path 1504 is derived as a position deviated from the crossroads, as illustrated in FIG. 17A. In addition, for example, if the time until the self-vehicle 1501 reaches the intersection 1505 is calculated as 3 seconds, and the time until the other vehicle 1502 reaches the intersection 1505 is calculated as 3 seconds, and these seconds are determined to be equal to or less than a threshold (for example, 4 seconds), then the possibility of collision is determined to be high, and a notification to the driver is performed.

In FIG. 17B illustrating an actual path, a path obtained from traveling of the other vehicle 1502 is actually a path 1506, and a point 1507 is a point having a possibility of collision. In this case, it is considered that the time required for the traveling self-vehicle 1501 to reach the point 1507 is sufficiently shorter than the time required for the other vehicle 1502 to reach the point 1507. Therefore, since the possibility of collision is actually low, the notification to the driver is not necessary. However, since the possibility of collision is determined to be high as described above, the notification to the driver is inappropriately performed.

According to the present embodiment, even in a case where the road connecting to the crossroads has a curved shape as illustrated in FIGS. 16A and 16B and FIGS. 17A and 17B, the notification to the driver can be appropriately performed.

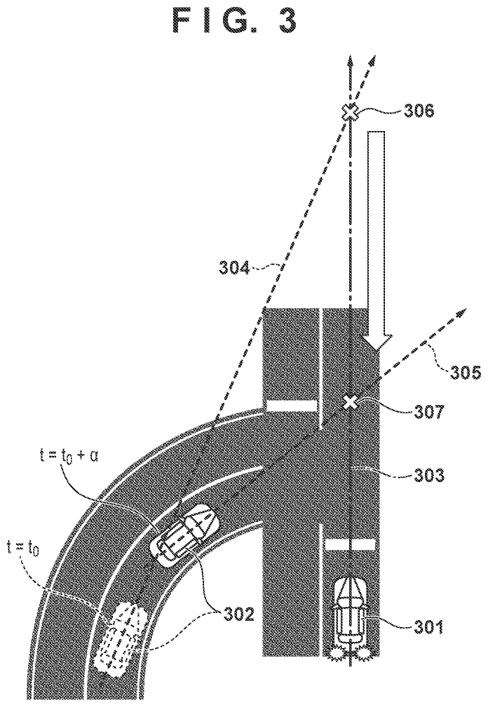

FIG. 3 is a view for describing the operation of the present embodiment. A self-vehicle 301 is in a stopped state or a traveling state. Another vehicle 302 is another vehicle entering a crossroads along a curved road. FIG. 3 illustrates positions of the other vehicle 302 at two times, a time t=t0 and a time t=t0+α after a predetermined time α has elapsed. A path 303 is a future path estimated with the current position of the self-vehicle 301 serving as a base point. A path 304 is a future path estimated using a position of the other vehicle 302 at the time t=t0 as a base point, and a path 305 is a future path estimated using a position of the other vehicle 302 at the time t=t0+α as the base point. An intersection 306 is an intersection between the path 304 and the path 303, and an intersection 307 is an intersection between the path 305 and the path 303.

When the other vehicle 302 enters the crossroads along the curved road as illustrated in FIG. 3, a behavior of the intersection of the paths is movement to the self-vehicle 301 side along the path 303 estimated for the self-vehicle 301. In the present embodiment, when the behavior of the intersection between the path estimated for the self-vehicle 301 and the path estimated for the other vehicle 302 is as described above, the condition for performing a notification to the driver is set to a condition corresponding to the case as illustrated in FIG. 3.

For example, when the self-vehicle 301 stops, the threshold of the time until the intersection is reached is made greater than the reference value, so that the notification to the driver is more likely to be performed. Here, the reference value is a threshold used in a case where the other vehicle enters a crossroads along a linear road, that is, a case where the intersection between the future path estimated for the self-vehicle and the future path estimated for the other vehicle is in a stationary state even when the other vehicle moves. That is, by making the threshold of the time until the intersection is reached greater than the reference value, the timing until the notification to the driver is performed is advanced. Such a change in the threshold can prevent the notification to the driver from failing to be performed as described in FIGS. 16A and 16B. In addition, for example, when the self-vehicle 301 is traveling, the threshold of the time until the intersection is reached is made smaller than the reference value, so that the notification to the driver is less likely to be performed. That is, by making the threshold of the time until the intersection is reached smaller than the reference value, the timing until the notification to the driver is performed is delayed. Such a change in the threshold can prevent the notification to the driver from being inappropriately performed as described in FIGS. 17A and 17B.

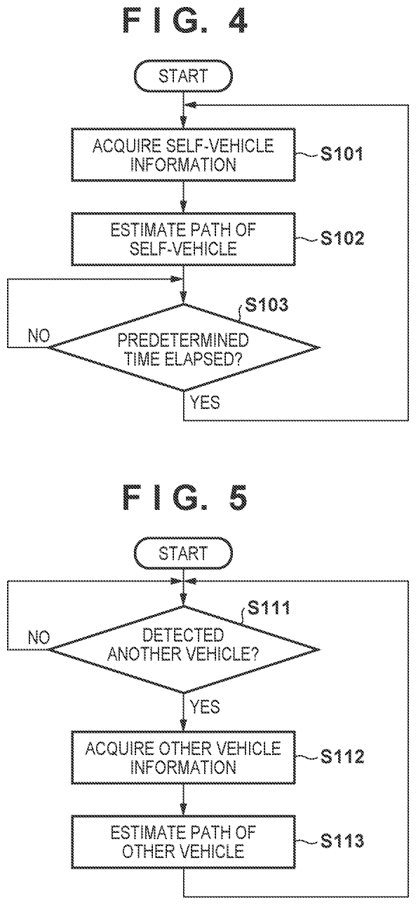

FIGS. 4, 5, and 6 are flowcharts illustrating control processing of driving support in the present embodiment. Processing in FIGS. 4, 5, and 6 is realized, for example, when the controller 200 reads and executes a program stored in a storage region such as a ROM. In addition, processing in FIGS. 4, 5, and 6 is executed, for example, when the self-vehicle 301 on which the controller 200 is mounted is located near a crossroads. For example, processing in FIGS. 4, 5, and 6 may be performed when it is recognized that the vehicle is traveling near the crossroads by scene recognition by the controller 200.

First, processing in FIG. 4 will be described. In S101, the controller 200 acquires information indicating a traveling situation of the self-vehicle. The information indicating the traveling situation of the self-vehicle includes, for example, position information, speed information, information indicating the behavior and posture of the vehicle such as yaw rate. In S102, the controller 200 estimates a future path of the self-vehicle based on the information acquired in S101. For example, the controller 200 estimates a straight line extending in the direction of the absolute orientation with the current position serving as a base point as the future path of the self-vehicle based on the position information, the speed information, the posture information, and the like of the self-vehicle acquired in S101, and stores the estimated straight line in the storage region in the controller 200. For example, the path 303 in FIG. 3 corresponds to the path estimated in S102.

In S103, the controller 200 determines whether or not a predetermined time has elapsed. Here, when it is determined that the predetermined time has not elapsed, processing in S103 is repeated, and when it is determined that the predetermined time has elapsed, processing from S101 is repeated.

Next, processing in FIG. 5 will be described. In S111, the controller 200 determines whether or not another vehicle is present around the self-vehicle. The presence of the other vehicle is determined, for example, when identification information on a vehicle other than the self-vehicle is received through vehicle-to-vehicle communication. Here, when it is determined that the other vehicle is not present, processing from S111 is repeated. On the other hand, when it is determined that the other vehicle is present, processing proceeds to S112. In S112, the controller 200 acquires information indicating a traveling situation of the other vehicle that has been determined to be present in S111. The controller 200 acquires information from the other vehicle present within a communication range of the communication device 219. Here, the information indicating the traveling situation of the other vehicle includes, for example, position information, speed information, information indicating the behavior and posture of the vehicle such as yaw rate. In S113, the controller 200 estimates a future path of the other vehicle based on the information acquired in S112, and stores the future path in the storage region in the controller 200. For example, the controller 200 estimates a straight line extending in the direction of the absolute orientation with the current position serving as a base point as the future path of the other vehicle based on the position information, the speed information, the posture information, and the like of the other vehicle acquired in S112. For example, the path 304 in FIG. 3 corresponds to the path estimated in S113. After S113, processing from S111 is repeated. For example, when it is determined in S111 that further another vehicle is present, information indicating a traveling situation of the further other vehicle is acquired in S112. That is, when a plurality of other vehicles are present, information is acquired for each of the other vehicles.

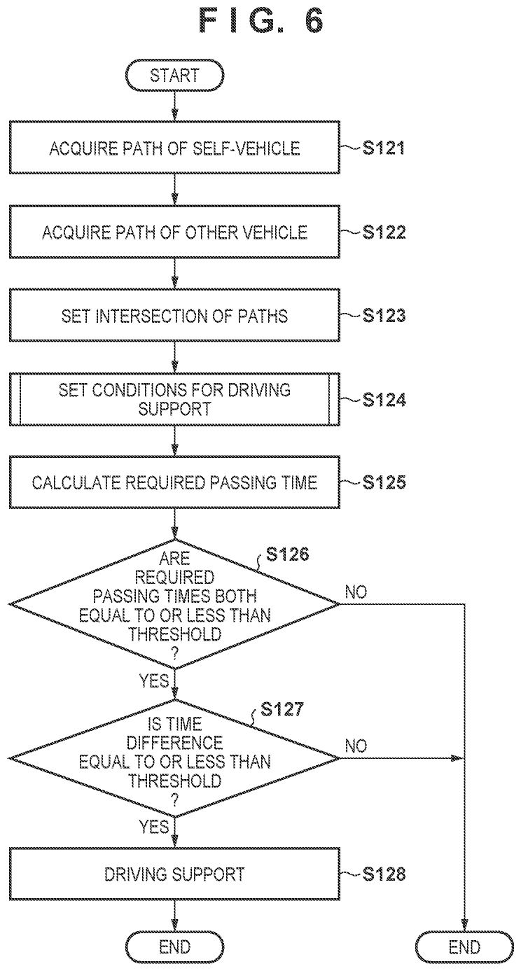

Processing in FIG. 6 is started when the path of the self-vehicle is estimated by processing in FIG. 4 and the path of the other vehicle is estimated by processing in FIG. 5. In S121, the controller 200 acquires the path of the self-vehicle stored in the storage region in the controller 200.

In S122, the controller 200 acquires the path of the other vehicle stored in the storage region in the controller 200. Then, in S123, the controller 200 sets an intersection between the path of the self-vehicle acquired in S121 and the path of the other vehicle acquired in S122. Note that the intersection is not necessarily set for the path of the other vehicle acquired in S122. For example, although not illustrated in FIG. 3, the path estimated for the other vehicle traveling in the opposite lane of the self-vehicle 301 is parallel to the path 303 estimated for the self-vehicle 301, and thus an intersection is not set. The path of the other vehicle for which the intersection is not set may be discarded in this step. For example, the intersection 306 in FIG. 3 corresponds to the intersection set in S123. Hereinafter, a description will be given on the assumption that the intersection 306 between the path 304 estimated for the other vehicle 302 and the path 303 estimated for the self-vehicle 301 is set in the scene illustrated in FIG. 3. In S124, the controller 200 sets conditions for driving support.

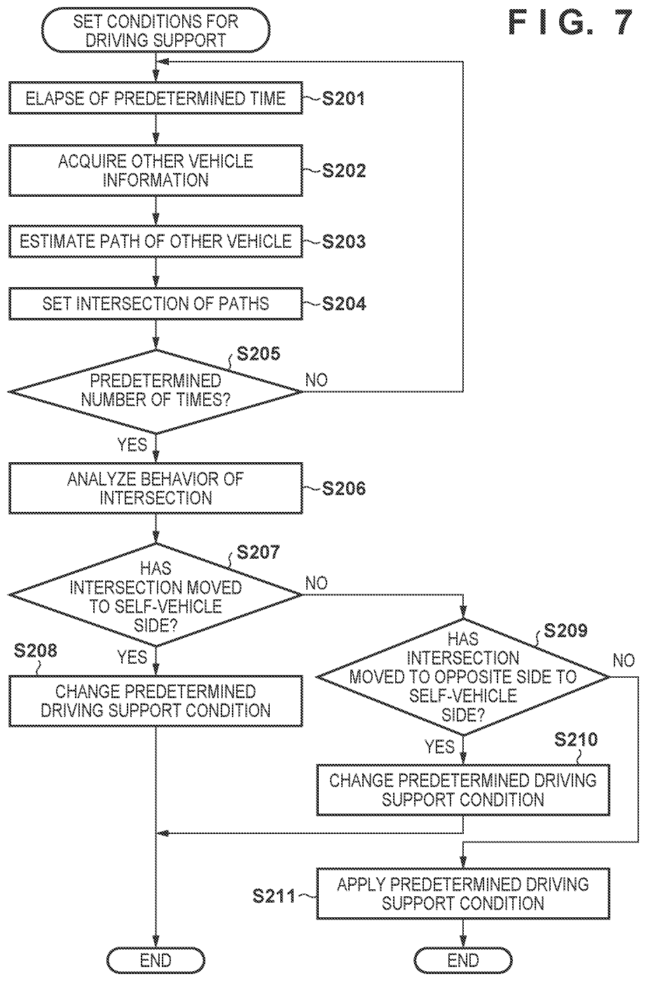

FIG. 7 is a flowchart illustrating processing for setting the conditions for driving support in S124. In S201, the controller 200 waits for a predetermined time to elapse. In S202, the controller 200 acquires information indicating a traveling situation of the other vehicle 302 corresponding to the intersection set in S123. In S203, the controller 200 estimates a future path of the other vehicle based on the information acquired in S202. The estimation of the path of the other vehicle here is performed by the same method as the estimation of the path of the other vehicle in S113. In S204, the controller 200 sets an intersection between the path estimated for the self-vehicle 301 in S102 and the path estimated for the other vehicle 302 in S203. Then, in S205, it is determined whether or not processing in S201 to S204 has been performed a predetermined number of times. The predetermined number of times may be any number of times as long as the behavior of the intersection can be analyzed. When it is determined that processing has not been performed the predetermined number of times, processing from S201 is repeated. On the other hand, when it is determined that processing has been performed the predetermined number of times, processing proceeds to S206.

The path estimated for the other vehicle in S113 corresponds to, for example, the path 304 corresponding to t=t0 in FIG. 3. The intersection set in S123 corresponds to, for example, the intersection 306 in FIG. 3. Then, the path estimated for the other vehicle in S203 after the predetermined time α has elapsed corresponds to, for example, the path 305 corresponding to t=t0+α in FIG. 3. In addition, the intersection set in S204 corresponds to, for example, the intersection 307 in FIG. 3. The controller 200 stores the intersection set in S204 in the storage region such as a RAM.

In S206, the controller 200 analyzes the behavior of the intersection on the path estimated for the self-vehicle 301 in S102 based on a plurality of intersections stored in the storage region. Then, in S207, the controller 200 determines whether or not the intersection moves to the self-vehicle 301 side based on the analysis results. In this determination, it may be determined that the intersection moves to the self-vehicle 301 side, for example, if the distance between the intersection and the self-vehicle 301 becomes short with the lapse of time on the path estimated for the self-vehicle 301 in S102. In addition, the determination may be made, for example, based on the fact that the position of the intersection on the path estimated for the self-vehicle 301 in S102 moves to the self-vehicle 301 side. Here, for example, a coordinate represented by latitude or longitude may be used as the position. That is, the behavior of the intersection may be analyzed based on a change in the distance to the self-vehicle 301, or may be analyzed based on a change in the position of the intersection itself.

When it is determined in S207 that the intersection moves to the self-vehicle 301 side, the controller 200 changes a predetermined driving support condition in S208. Here, the predetermined driving support condition is a value (threshold) determined in advance as a time until the self-vehicle 301 and the other vehicle 302 reach the intersection in a case where the road connecting to the crossroads is not a curved shape as illustrated in FIG. 3 but a straight line. For example, the time is 3 seconds set as a time during which the vehicle can safely stop without requiring sudden braking (for example, an acceleration of 0.3 G or more) while traveling at 30 km/h. The value may be a value determined according to the vehicle speed.

In S208, the controller 200 changes the predetermined driving support condition in accordance with the current speed of the self-vehicle 301. For example, when the speed of the self-vehicle 301 is equal to or less than a slowdown speed (for example, 5 km/h), the predetermined threshold is changed to be longer, and the changed value is set as the threshold of the time until the self-vehicle reaches the intersection. In other words, the predetermined driving support condition is changed so that the notification to the driver is more likely to be performed (the timing of the notification is advanced). On the other hand, when the speed of the self-vehicle 301 is a regular speed (higher than the slowdown speed), the predetermined threshold is changed to be shorter, and the changed value is set as the threshold of the time until the self-vehicle reaches the intersection. In other words, the predetermined driving support condition is changed so that the notification to the driver is less likely to be performed (the timing of the notification is delayed). After S208, processing in FIG. 5 ends.

When it is determined in S207 that the intersection does not move to the self-vehicle 301 side, the controller 200 determines in S209 whether or not the intersection moves to the opposite side to the self-vehicle 301 side. In this determination, it may be determined that the intersection moves to the opposite side to the self-vehicle 301 side, for example, if the distance between the intersection and the self-vehicle 301 becomes long with the lapse of time on the path estimated for the self-vehicle 301 in S102. In addition, the determination may be made, for example, based on the fact that the position of the intersection on the path estimated for the self-vehicle 301 in S102 moves to the opposite side to the self-vehicle 301 side. Here, for example, a coordinate represented by latitude or longitude may be used as the position. That is, the behavior of the intersection may be analyzed based on a change in the distance to the self-vehicle 301, or may be analyzed based on a change in the position of the intersection itself.

When it is determined in S209 that the intersection moves to the opposite side to the self-vehicle 301 side, the controller 200 changes the predetermined driving support condition in S210. The change here is made, for example, such that the notification to the driver is less likely to be performed or not performed. For example, the change may be made by setting an extremely short time such as 0.1 seconds as a threshold of the time until the intersection is reached.

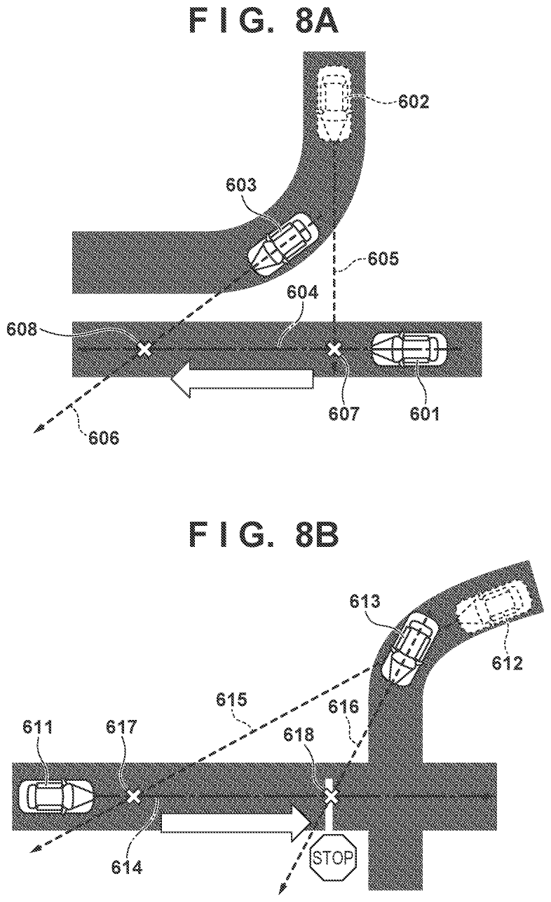

Here, a case where it is determined that the intersection moves away from the self-vehicle will be described. FIGS. 8A and 8B are views for describing the case where it is determined that the intersection moves to the opposite side to the self-vehicle side. FIG. 8A illustrates a case where the road on which a self-vehicle 601 travels is different from the road on which another vehicle 602 travels. Another vehicle 603 corresponds to a position after a predetermined time α has elapsed from the position of the other vehicle 602. A path 604 is a future path of the self-vehicle 601 estimated in S102. A path 605 is a future path of the other vehicle 602 estimated in S113. A path 606 is a future path of the other vehicle 603 estimated in S203. An intersection 607 is an intersection set in S123, and an intersection 608 is an intersection set in S204.

In the case as illustrated in FIG. 8A, the intersection moves from the intersection 607 to the intersection 608 with the lapse of time a. Since the road on which the self-vehicle 601 travels and the road on which the other vehicle 602 travels are different from each other, the possibility of collision is low and thus the notification to the driver is not necessary. In the present embodiment, when the intersection moves to the opposite side to the self-vehicle side, a change is made so that the notification to the driver is less likely to be performed or not performed; thus, it is possible to prevent an inappropriate notification. In addition, even in a case where the road on which the self-vehicle 601 travels merges with the road on which the other vehicle 602 travels, the intersection similarly moves to the opposite side to the self-vehicle 601 side. In such a case, since the other vehicle 602 joins on the traveling direction side of the self-vehicle 601, the other vehicle 602 is likely to come into the field of view of the driver of the self-vehicle 601, and thus the necessity of a notification to the driver is low. In the present embodiment, when the intersection moves to the opposite side to the self-vehicle side, a change is made so that the notification to the driver is less likely to be performed or not performed; thus, it is possible to reduce the frequency in an unnecessary notification.

FIG. 8B illustrates a case where another vehicle 612 enters a crossroads along a curved road. Another vehicle 613 corresponds to a position after a predetermined time α has elapsed from the position of the other vehicle 612. A path 614 is a future path of the self-vehicle 611 estimated in S102. A path 615 is a future path of the other vehicle 612 estimated in S113. A path 616 is a future path of the other vehicle 613 estimated in S203. An intersection 617 is an intersection set in S123, and an intersection 618 is an intersection set in S204.

In the case as illustrated in FIG. 8B as well, the intersection moves from the intersection 617 to the intersection 618 with the lapse of time α. However, unlike in the case of FIG. 3, the other vehicle 612 enters the crossroads while curving from the front direction of the self-vehicle 611. That is, the other vehicle 612 enters the crossroads within the field of view of the driver of the self-vehicle 611, and thus the necessity of a notification to the driver is low. In the present embodiment, when the intersection moves to the opposite side to the self-vehicle side, a change is made so that the notification to the driver is less likely to be performed or not performed; thus, it is possible to reduce the frequency in an unnecessary notification.

When it is determined in S209 that the intersection does not move to the opposite side to the self-vehicle 301 side, the controller 200 applies the predetermined driving support condition in S211 and then ends processing in FIG. 7. The case where it is determined in S209 that the intersection does not move to the opposite side to the self-vehicle 301 side includes a state in which the intersection is stationary. Such a case corresponds to a case where the road connecting to the crossroads is not a curved shape as illustrated in FIG. 3 but a straight line. The “stationary state” includes a state in which there is a slight fluctuation in the position of the intersection. For example, a case where the position of the intersection remains within a range of ±0.05% of the distance to the self-vehicle 301 may be determined as the “stationary state”.

A description will be given with reference to FIG. 6 again. After S124, in S125, the controller 200 calculates a required passing time for each of the self-vehicle 301 and the other vehicle 302 to pass the intersection. The required time is calculated based on, for example, the distance from the position of each vehicle at a certain time point to the intersection, and the speed information of each vehicle. Time to collision (TTC) may be used as the required passing time. Then, in S126, the controller 200 determines whether or not the required passing time of each of the self-vehicle 301 and the other vehicle 302 calculated in S125 is equal to or less than a threshold set as the driving support condition in S124. Here, the threshold set as the driving support condition in S124 is, for example, a threshold changed so that the predetermined threshold is made longer in S208 when the speed of the self-vehicle 301 is equal to or less than a slowdown speed (for example, 5 km/h). Or, the threshold is, for example, a threshold changed so that the predetermined threshold is made shorter in S208 when the speed of the self-vehicle 301 is faster than the slowdown speed. When both required passing times of the self-vehicle 301 and the other vehicle 302 are not equal to or less than the threshold in S126, the notification to the driver is not necessary, and thus processing in FIG. 6 ends. On the other hand, when both required passing times of the self-vehicle 301 and the other vehicle 302 are equal to or less than the threshold, processing proceeds to S127.

In S127, the controller 200 determines whether or not the difference between the required passing time of the self-vehicle 301 and the required passing time of the other vehicle 302 that are calculated in S125 is equal to or less than a threshold. Here, when the difference in the required passing time is greater than the threshold, processing in FIG. 6 ends without executing driving support in S128. On the other hand, when it is determined that the difference in the required passing time is equal to or less than the threshold, processing proceeds to S128.

In S128, the controller 200 executes driving support for the driver of the self-vehicle 301. As the driving support, a notification to the driver is performed, for example. As the notification to the driver, for example, a message reporting approach of the other vehicle may be displayed on the display device 217. Or, for example, the message may be output by voice via the speaker 216. In addition, as the driving support, steering control or braking control for emergency avoidance may be performed. Alternatively, the notification to the driver, steering control, and braking control may be combined. After S128, the controller 200 returns the driving support condition changed in S208 and S210 to the predetermined driving support condition, and then ends processing in FIG. 6.

As described above, in the present embodiment, even when the road connecting to the crossroads has a curved shape as illustrated in FIG. 3, it is possible to appropriately execute driving support for the driver of the self-vehicle based on the approach of the other vehicle traveling on the road.

In the present embodiment, it has been described that driving support for the self-vehicle 301 is executed in S128. However, driving support for the other vehicle 302 may be performed. In this case, in S128, the controller 200 may transmit information indicating that the self-vehicle 301 is approaching the other vehicle 302 to the other vehicle 302 via the communication device 219. In this case, the information to be transmitted may be display data that can be displayed on a panel or the like, or may be voice data that can be output by a speaker or the like. In addition, in S128, driving support for the other vehicle 302 may be executed together with driving support for the self-vehicle 301 or instead of driving support for the self-vehicle 301. Furthermore, the same type of driving support (for example, a notification to the driver) may be executed in driving support for the self-vehicle 301 and driving support for the other vehicle 302, or different types of driving support may be executed.

In the present embodiment, the case where the self-vehicle 301 enters the crossroads along a straight road and the other vehicle 302 enters the crossroads along a curved road has been described. However, even when the self-vehicle 301 enters along the curved road and the other vehicle 302 enters the crossroads along the straight road, a change in the driving support condition may be made based on a change in the position of the intersection. Processing in FIG. 7 is similarly applicable to the case where the positions of the self-vehicle 301 and the other vehicle 302 are replaced with each other in FIG. 3. Hereinafter, processing for a case where the other vehicle 302 is the self-vehicle 301 and the self-vehicle 301 is the other vehicle 302 in FIG. 3 will be described.

At t=t0, in S202, the controller 200 acquires information indicating a traveling situation of the other vehicle 302 corresponding to the intersection set in S123. In S203, the controller 200 estimates a future path of the other vehicle based on the information acquired in S202. The future path of the other vehicle here is the path 303. In S204, the controller 200 sets the intersection 306 between the path 304 estimated for the self-vehicle 301 at the present time and the path 303 estimated for the other vehicle 302 in S203. Then, in S205, it is determined whether or not processing in S201 to S204 has been performed a predetermined number of times.

At t=t1, in S202, the controller 200 acquires information indicating a traveling situation of the other vehicle 302 corresponding to the intersection set in S123. In S203, the controller 200 estimates a future path of the other vehicle based on the information acquired in S202. The future path of the other vehicle here is the path 303. In S204, the controller 200 sets the intersection 307 between the path 305 estimated for the self-vehicle 301 at the present time and the path 303 estimated for the other vehicle 302 in S203.

As a result of the analysis of the behavior of the intersection in S206, the controller 200 determines whether or not the intersection moves to the self-vehicle 301 side on the path based on the analysis results in S207. In this determination, it is determined that the intersection moves to the self-vehicle 301 side, for example, if the distance between the intersection 307 and the self-vehicle 301 becomes shorter than the distance between the intersection 306 and the self-vehicle 301 with the lapse of time based on the paths 304 and 305 estimated for the self-vehicle 301. In the case illustrated in FIG. 3, since the above-described distance becomes shorter, the predetermined driving support condition is changed so that the notification to the driver is more likely to be performed when the speed of the other vehicle 302 is equal to or less than the slowdown speed.

In addition, in S209, the controller 200 determines whether or not the intersection moves to the opposite side to the self-vehicle 301 side based on the results of the analysis in S206. In this determination, it is determined that the intersection moves to the opposite side to the self-vehicle 301 side, for example, if the distance between the intersection 307 and the self-vehicle 301 becomes longer than the distance between the intersection 306 and the self-vehicle 301 with the lapse of time based on the paths 304 and 305 estimated for the self-vehicle 301. For example, this case corresponds to a case where the traveling direction of the self-vehicle 301 gradually changes from the direction crossing the straight road of the other vehicle 302 to the same direction as the straight road (for example, merging). In such a case, since the distance becomes longer, the predetermined driving support condition is changed so that the notification to the driver is less likely to be performed or not performed.

That is, processing after the determination results in S207 and S209 is the same as the above-described processing. In this manner, processing in FIG. 7 is similarly applicable to the case where the positions of the self-vehicle 301 and the other vehicle 302 are replaced with each other in FIG. 3.

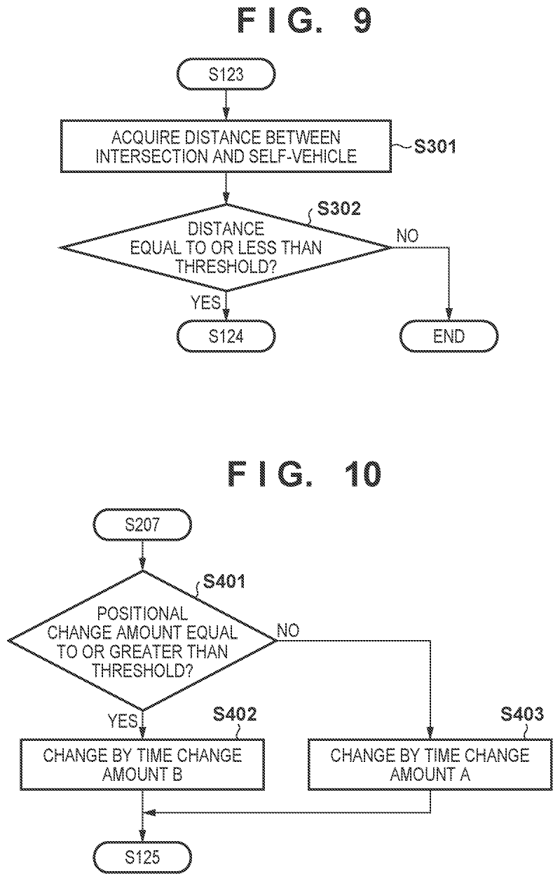

In addition, in processing in FIG. 6, the distance between the set intersection and the self-vehicle 301 may be acquired after S123. FIG. 9 is a flowchart illustrating processing in this case. After the intersection of the paths is set in S123, the controller 200 acquires the distance between the intersection and the self-vehicle 301 on the path 303 in S301. Then, in S302, the controller 200 determines whether or not the distance is equal to or less than a threshold. Here, when it is determined that the distance is equal to or less than the threshold, processing in and after S124 is executed. On the other hand, when it is determined that the distance is not equal to or less than the threshold, processing in FIGS. 9 and 6 ends. With such a configuration, driving support is not performed when the position of the intersection is apart by a certain distance or more, and thus it is possible to prevent the notification from being performed when the point having a possibility of collision is still far.

In addition, when it is determined in S207 that the intersection moves to the self-vehicle 301 side, the degree of change in the predetermined driving support condition may be changed according to the change amount of the position of the intersection. FIG. 10 is a flowchart illustrating processing in this case. FIG. 10 illustrates processing where it is determined in S207 that the intersection moves to the self-vehicle 301 side. In S401, the controller 200 determines whether or not the movement change of the intersection is equal to or greater than a threshold. The movement change of the intersection may be, for example, a change amount of the position of the intersection per unit time. When it is determined that the movement change of the intersection is not equal to or greater than the threshold, the controller 200 changes the predetermined driving support condition in S403 as described in S208. In FIG. 10, the change amount at that time is illustrated as a time change amount A. Here, the change amount of the position of the intersection when it is determined that the movement change of the intersection is equal to or greater than the threshold is set as a first change amount, and the change amount of the position of the intersection when it is determined that the movement change of the intersection is not equal to or greater than the threshold is set as a second change amount. For example, when the change amount of the position of the intersection is the second change amount (S401: No) and the speed of the self-vehicle 301 is a regular speed, the predetermined threshold is shortened by the time change amount A as the threshold of the time until the intersection is reached. Or, for example, when the change amount of the position of the intersection is the second change amount (S401: No) and the speed of the self-vehicle 301 is a slowdown speed, the predetermined time is extended by the time change amount A as the threshold of the time until the intersection is reached.

On the other hand, when it is determined in S401 that the movement change of the intersection is equal to or greater than the threshold, that is, the change amount of the position of the intersection is the first change amount, the controller 200 changes the predetermined driving support condition in S402 by a time change amount B that is greater than the time change amount A. The case where it is determined that the movement change of the intersection is equal to or greater than the threshold is, for example, a case where the curvature of the curve of the road on which the other vehicle 302 is traveling is relatively large. In that case, it is estimated that the movement change of the intersection will become larger thereafter. Therefore, for example, when the change amount of the position of the intersection is the first change amount (S401: Yes) and the speed of the self-vehicle 301 is a slowdown speed, the controller 200 extends the predetermined threshold by the time change amount B as the threshold of the time until the intersection is reached. That is, the notification to the driver is more likely to be performed than in the case of S403. It is assumed that the other vehicle 302 that has finished turning a curve having a large curvature enters the crossroads in a very short time, and there is a possibility that a collision occurs before the self-vehicle 301 increases the speed to the regular speed. According to the present embodiment, when it is determined that the movement change of the intersection is great, the change amount of the predetermined driving support condition is increased; thus, it is possible to further raise the possibility of collision avoidance.

On the other hand, for example, when the change amount of the position of the intersection is the first change amount (S401: Yes) and the speed of the self-vehicle 301 is a regular speed, the predetermined threshold is shortened by the time change amount B as the threshold of the time until the intersection is reached. That is, the notification to the driver is less likely to be performed than in the case of S403. The fact that the movement change of the intersection is great indicates that the other vehicle 302 is in a state of turning on the curve. Therefore, it is assumed that there is a high possibility that the self-vehicle 301 traveling at the regular speed can pass the crossroads earlier than the other vehicle 302. According to the present embodiment, when it is determined that the movement change of the intersection is great, the change amount of the predetermined driving support condition is increased, and thus it is possible to further lower the frequency in an unnecessary notification. After S402 or S403, processing proceeds to S125 in FIG. 6.

### Second Embodiment

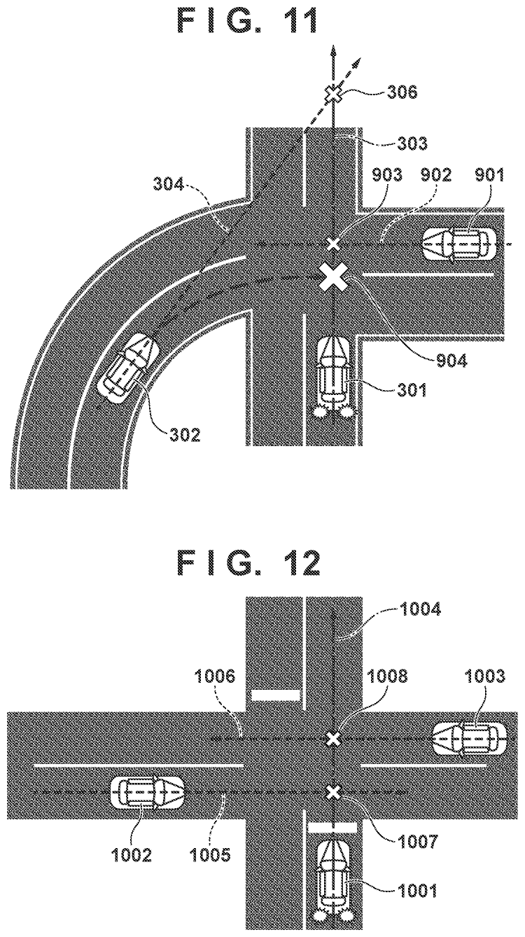

Hereinafter, an embodiment will be described with respect to points different from the first embodiment. In the first embodiment, a case of the crossroads as illustrated in FIG. 3 has been described as an example. In FIG. 3, a vehicle entering from the right side of the crossroads is not considered. However, in reality, it is assumed that another vehicle 901 entering from the right side of the crossroads is present as illustrated in FIG. 11. In FIG. 11, a path 902 is a future path estimated as a straight line with the current position of the other vehicle 901 serving as a base point. The intersection 903 is an intersection between the path 902 and the path 303.

When a plurality of intersections with paths estimated for each of a plurality of other vehicles are present, an intersection closer to the self-vehicle is usually preferentially determined as a processing target, so that a possibility of collision with the corresponding other vehicle is determined and driving support is executed. FIG. 12 is a view illustrating a case where a road connecting to a crossroads is a straight line. FIG. 12 illustrates the self-vehicle 1001 entering the crossroads from below, another vehicle 1002 entering from the left side, and another vehicle 1003 entering from the right side. A path 1004 is a future path estimated as a straight line with the current position of the self-vehicle 1001 serving as a base point. A path 1005 is a future path estimated as a straight line with the current position of the other vehicle 1002 serving as a base point. A path 1006 is a future path estimated as a straight line with the current position of the other vehicle 1003 serving as a base point. An intersection 1007 is an intersection between the path 1004 and the path 1005, and an intersection 1008 is an intersection between the path 1004 and the path 1006. When the above-described method for determining the intersection is applied to FIG. 12, the intersection 1007 is determined as the processing target more preferentially than the intersection 1008, so that the possibility of collision with the other vehicle 1002 is determined and driving support is executed.

However, when the above-described method for determining the intersection is applied to the vehicle entering the crossroads along a curved road as in the present embodiment, the intersection 903 is determined more preferentially than the intersection 306 as illustrated in FIG. 11. As indicated by a point 904 in FIG. 11, since it is assumed that the other vehicle 302 is actually more likely to collide with the self-vehicle 301 than the other vehicle 901, it is necessary that the intersection 306 be determined more preferentially than the intersection 903.

In the present embodiment, when a plurality of intersections between the path estimated for each of the plurality of other vehicles and the path estimated for the self-vehicle are present, priority is set for each intersection. Then, an intersection set with the highest priority is determined as the processing target, so that the possibility of collision with the other vehicle corresponding to the intersection is determined and driving support is executed.

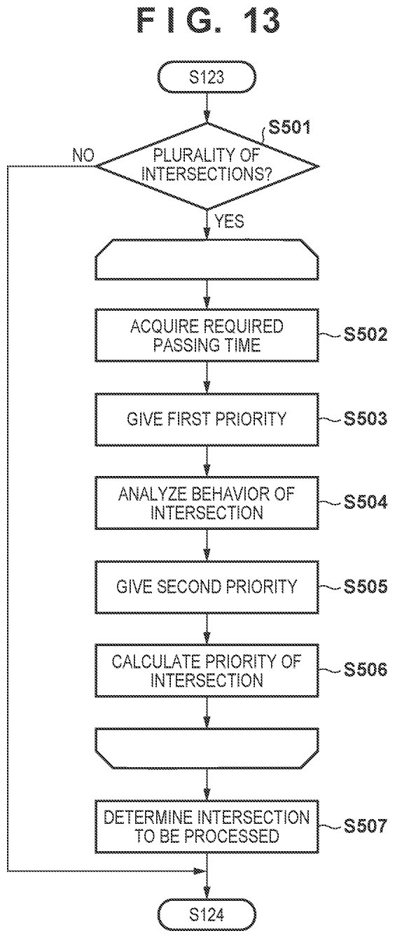

FIG. 13 is a flowchart illustrating processing for determining the intersection to be processed. Processing in FIG. 13 is performed after S123 in FIG. 6. After S123, the controller 200 determines in S501 whether or not a plurality of intersections set in S123 are present. Here, when it is determined that a plurality of intersections are not present, processing proceeds to S124 in FIG. 6. On the other hand, when it is determined that a plurality of intersections are present, processing proceeds to processing in and after S502. Subsequent processing in S502 to S506 is repeatedly executed for each of the plurality of intersections.

In S502, the controller 200 focuses on one of the intersections and acquires a required passing time for the self-vehicle 301 to pass the intersection. The required passing time is calculated, for example, based on the speed of the self-vehicle 301 at that time and the distance to the intersection on the path estimated for the self-vehicle. In S503, the controller 200 gives (sets) a first priority to the intersection currently focused on based on the required passing time calculated in S502. Here, the first priority is priority determined in advance for the range of the required passing time, and is, for example, as follows.
4 points when the required passing time is less than 3 seconds
3 points when the required passing time is 3 seconds to 3.5 seconds
2 points when the required passing time is equal to or more than 3.5 seconds

For example, in FIG. 11, when the required passing time of the self-vehicle 301 for the intersection 306 is 5 seconds, 2 points are given as the first priority to the intersection 306. When the required passing time of the self-vehicle 301 for the intersection 903 is 3 seconds, 3 points are given as the first priority to the intersection 903. In addition, in FIG. 12, when the required passing time of the self-vehicle 1001 for the intersection 1007 is 2.9 seconds, 4 points are given as the first priority to the intersection 1007. When the required passing time of the self-vehicle 1001 for the intersection 1008 is 3.3 seconds, 3 points are given as the first priority to the intersection 1008.

Next, in S504, the controller 200 analyzes a behavior of the intersection. For example, the controller 200 determines whether the intersection currently focused on is stationary, moves to the self-vehicle side on the path estimated for the self-vehicle, or moves to the opposite side to the self-vehicle side based on the position of the intersection at a plurality of times. In the determination here, it is merely required to divide the behavior of the intersection into the above-described three types, and for example, the determination may be performed based on two positions acquired at minute time intervals. In S505, the controller 200 gives a second priority to the intersection currently focused on based on the analysis results in S504. Here, the second priority is priority determined in advance for the behavior of the intersection, and is, for example, as follows.
0 points when the intersection is stationary
2 points when the intersection moves to the self-vehicle side
0 points when the intersection moves to the opposite side to the self-vehicle side

For example, in FIG. 11, when the intersection 306 moves to the self-vehicle side, 2 points are given as the second priority to the intersection 306. When the intersection 903 is stationary, 0 points are given as the second priority to the intersection 903. In addition, in FIG. 12, when the intersection 1007 is stationary, 0 points are given as the second priority to the intersection 1007. When the intersection 1008 is stationary, 0 points are given as the second priority to the intersection 1008.

Next, in S506, the controller 200 calculates the priority for the intersection currently focused on. For example, the controller 200 calculates the sum of the first priority given in S503 and the second priority given in S505. For example, in FIG. 11, 2+2=4 points are derived for the intersection 306, and 3+0=3 points are derived for the intersection 903. In FIG. 12, 4+0=4 points are derived for the intersection 1007. 3+0=3 points are derived for the intersection 1008.

Processing in S502 to S506 is repeated for each of the plurality of intersections. Processing in S502 to S506 for each of the plurality of intersections may be executed in parallel.

In S507, the controller 200 determines the intersection to be processed for driving support based on the priority calculated in S506 for each intersection. For example, the controller 200 determines an intersection with the highest priority as the intersection to be processed. For example, in FIG. 11, since the priority of the intersection 306 is higher than the priority of the intersection 903, the intersection 306 is determined as the intersection to be processed. In addition, in FIG. 12, since the priority of the intersection 1007 is higher than the priority of the intersection 1008, the intersection 1007 is determined as the intersection to be processed. After S507, processing proceeds to S124 in FIG. 6. In S124, processing in FIG. 7 is executed for the other vehicle corresponding to the intersection determined as the processing target.

As described above, according to the present embodiment, it is possible to appropriately execute driving support even when a plurality of other vehicles are present.

In the present embodiment, a case of the crossroads as illustrated in FIG. 11 has been described as an example. However, when a plurality of other vehicles are present, not all the other vehicles are traveling on the road; for example, a case is assumed where another vehicle traveling in a parking lot provided adjacent to the road is detected in S111. In such a case, since it is considered that the possibility of collision between the self-vehicle and the other vehicle traveling slowly in the parking lot is extremely low, it is desirable to exclude the vehicle from the processing target for driving support even if an intersection is set.

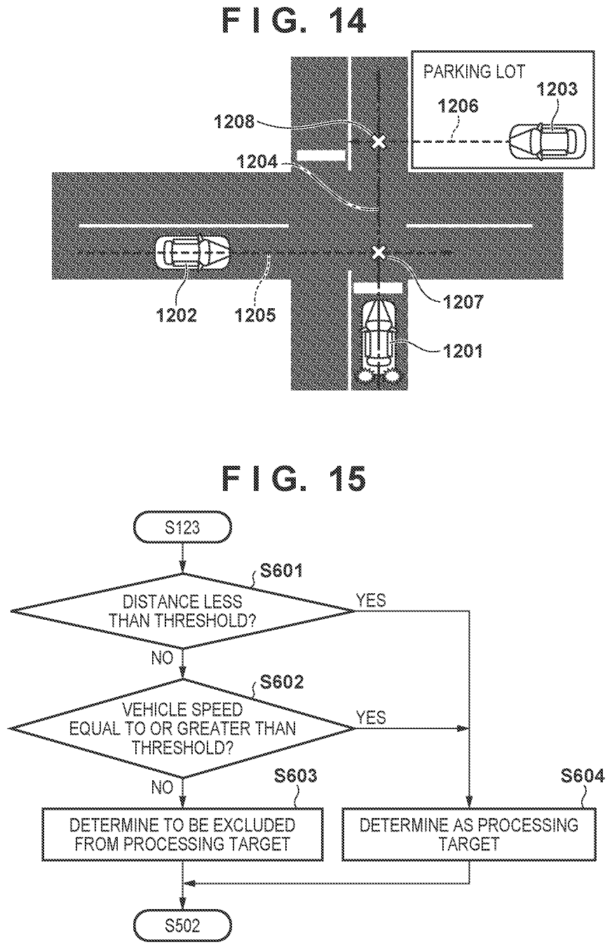

FIG. 14 is a view for describing a case where another vehicle is present in a parking lot adjacent to a crossroad. Here, a self-vehicle 1201 and another vehicle 1202 are traveling on the road, and another vehicle 1203 is traveling slowly in the parking lot. In FIG. 14, a path 1204 is a future path estimated as a straight line with the current position of the self-vehicle 1201 serving as a base point. In addition, a path 1205 is a future path estimated as a straight line with the current position of the other vehicle 1202 serving as a base point. A path 1206 is a future path estimated as a straight line with the current position of the other vehicle 1203 serving as a base point. An intersection 1207 is an intersection between the path 1204 and the path 1205, and an intersection 1208 is an intersection between the path 1204 and the path 1206.

As illustrated in FIG. 14, two intersections are present. In this case, the intersection nearer to the self-vehicle is preferentially determined as the processing target, so that the possibility of collision with the corresponding other vehicle is determined and driving support is executed. However, as described above, since it is considered that the possibility of collision with the other vehicle 1203 is extremely low, it is desirable from the viewpoint of the processing load to exclude the other vehicle from the processing target for driving support. Therefore, processing illustrated in FIG. 15 may be executed after S123 in FIG. 6.

FIG. 15 is a flowchart illustrating processing for limiting the processing target for driving support. FIG. 15 is executed for each intersection.

In S601, the controller 200 focuses on an intersection and determines whether or not the distance from the self-vehicle 1201 to the intersection is less than a threshold. This threshold corresponds to, for example, the threshold in S302 in FIG. 9. In addition, for example, TTC may be used as the threshold. When it is determined that the distance is less than the threshold, the controller 200 determines the intersection as a subsequent processing target in S604, and focuses on the next intersection and repeats processing from S601. With such a configuration, an intersection within a certain distance can be set as the processing target. On the other hand, when it is determined that the distance is not less than the threshold (equal to or greater than the threshold), the controller 200 determines in S602 whether or not the vehicle speed of the other vehicle corresponding to the intersection is equal to or greater than a threshold. The threshold here may be, for example, a walking speed of a person. When it is determined that the vehicle speed is equal to or greater than the threshold, the controller 200 determines the intersection as a subsequent processing target in S604, and focuses on the next intersection and repeats processing from S601. With such a configuration, another vehicle with a vehicle speed equal to or greater than a certain speed can be set as the processing target. On the other hand, when it is determined that the vehicle speed is not equal to or greater than the threshold (less than the threshold), the controller 200 determines the intersection as the one to be excluded from the processing target in S603, and focuses on the next intersection and repeats processing from S601. With such a configuration, for example, when the other vehicle 1203 in FIG. 14 is traveling slowly, the intersection 1208 is excluded from the processing target, so that processing in FIG. 13 (priority giving) is not performed on the intersection 1208 and thus the processing load can be reduced. When processing is performed on all the intersections, processing in and after S502 in FIG. 13 is performed, and priority giving is performed on the intersection determined as the processing target in S604.

As described above, since the other vehicle traveling slowly in the parking lot is determined to be excluded from the processing target for driving support, it is not necessary to perform processing for giving priority and thus it is possible to reduce the processing load. In addition, the determination criterion for excluding the other vehicle from the processing target for driving support is not limited to that illustrated in FIG. 15. For example, it may be determined whether the required passing time of the other vehicle to the intersection is equal to or more than a threshold. That is, when the other vehicle is traveling slowly, the required passing time to the intersection tends to be long. Therefore, when the required passing time is equal to or greater than the threshold, the other vehicle may be determined to be excluded from the processing target based on the determination results by determining that the other vehicle is traveling slowly. In addition, map information may be used as a determination criterion for excluding the other vehicle from the processing target for driving support. For example, the distance to be determined in S601 may be acquired from position information included in the map information.

### Summary of Embodiments

The vehicle control device according to each of the above-described embodiments includes: a first acquisition unit (S101) configured to acquire information indicating a traveling situation of a self-vehicle; a first estimation unit (S102) configured to estimate a future path of the self-vehicle based on the information indicating the traveling situation of the self-vehicle acquired by the first acquisition unit; a second acquisition unit (S112) configured to acquire information indicating a traveling situation of another vehicle that is different from the self-vehicle; a second estimation unit (S113) configured to estimate a future path of the other vehicle based on the information indicating the traveling situation of the other vehicle acquired by the second acquisition unit; a determination unit (FIG. 6) configured to determine whether or not to execute driving support based on a position change of an intersection between the future path of the self-vehicle estimated by the first estimation unit and the future path of the other vehicle estimated by the second estimation unit; and an execution unit (S128) configured to execute the driving support when the determination unit determines to execute the driving support.

With such a configuration, it is possible to appropriately perform driving support based on the possibility of collision between the vehicles even when the shape of the road entering the crossroads connects to the crossroads with a curve.

The determination unit is configured to determine (S126, S127) whether or not to execute the driving support further based on a first required passing time required for the self-vehicle to pass the intersection and a second required passing time required for the other vehicle to pass the intersection. The determination unit is configured to determine (S126) to execute the driving support when both the first required passing time and the second required passing time are equal to or less than a threshold. The determination unit is configured to determine (S127) to execute the driving support when a difference between the first required passing time and the second required passing time is equal to or less than a threshold.

With such a configuration, it is possible to execute driving support when the traveling situations of the self-vehicle and the other vehicle satisfy the conditions.

When the information indicating the traveling situation of the self-vehicle indicates a vehicle speed equal to or less than a threshold, the determination unit is configured to be more likely to determine (S208) to execute the driving support when the position of the intersection moves to the self-vehicle side than when the position of the intersection does not move to the self-vehicle side. When the information indicating the traveling situation of the self-vehicle indicates a vehicle speed greater than the threshold, the determination unit is configured to be less likely to determine (S208) to execute the driving support when the position of the intersection moves to the self-vehicle side than when the position of the intersection does not move to the self-vehicle side.

With such a configuration, it is possible to make driving support more likely to be performed when the self-vehicle stops, and to make driving support less likely to be performed when the self-vehicle is traveling at a regular speed, for example.

When the information indicating the traveling situation of the self-vehicle indicates the vehicle speed equal to or less than the threshold, the determination unit is configured to be more likely to determine (S208) to execute the driving support when a position change of the intersection is a first change amount than when the position change of the intersection is a second change amount smaller than the first change amount. When the information indicating the traveling situation of the self-vehicle indicates the vehicle speed greater than the threshold, the determination unit is configured to be less likely to determine (S208) to execute the driving support when the position change of the intersection is a first change amount than when the position change of the intersection is the second change amount smaller than the first change amount.

With such a configuration, it is possible to, when the curvature of the road on which the other vehicle travels is large, make driving support further more likely to be performed when the self-vehicle stops, and make driving support further less likely to be performed when the self-vehicle is traveling at a regular speed.

The determination unit is configured to be less likely to determine (S210) to execute the driving support when the position of the intersection moves to an opposite side to the self-vehicle side than when the position of the intersection moves to the self-vehicle side.

With such a configuration, it is possible to make driving support less likely to be performed in a situation in which executing driving support is not appropriate.

The vehicle control device further includes an acquisition unit (S201-S205) configured to acquire a position of the intersection at a first time and a position of the intersection at a second time after the first time. A case where the intersection moves to the self-vehicle side is a case where the position of the intersection at the second time is closer to the self-vehicle side than the position of the intersection at the first time. A case where the intersection moves to the opposite side to the self-vehicle side is a case where the position of the intersection at the second time is on the opposite side to the self-vehicle side compared to the position of the intersection at the first time.

With such a configuration, it is possible to analyze the behavior of the intersection, for example, through processing for repeatedly acquiring information indicating the traveling situation of the vehicle at predetermined time intervals.

The position change of the intersection is a position change within a predetermined distance from the self-vehicle.

With such a configuration, it is possible to prevent driving support from being executed when the intersection is far from the self-vehicle.

The determination unit being more likely to determine to execute the driving support includes increasing a threshold of a time required for the self-vehicle to pass the intersection, and the determination unit being less likely to determine to execute the driving support includes decreasing the threshold.

With such a configuration, it is possible to make driving support more or less likely to be performed by changing the predetermined threshold.

The vehicle control device further includes a setting unit (FIG. 13) configured to set priority for a first intersection between the future path of the self-vehicle and a future path of a first other vehicle and a second intersection between the future path of the self-vehicle and a future path of a second other vehicle. The determination unit is configured to determine whether or not to execute the driving support based on a position change of an intersection having a high priority from between the first intersection and the second intersection. The priority is set based on a behavior of the intersection and the required passing time required for the self-vehicle to pass the intersection.

With such a configuration, it is possible to appropriately determine the intersection to be processed even when a plurality of other vehicles are present.

The vehicle control device further includes an intersection determination unit (FIG. 13) configured to determine an intersection to be determined by the determination unit from a first intersection between the future path of the self-vehicle and the future path of a first other vehicle and a second intersection between the future path of the self-vehicle and the future path of a second other vehicle. The intersection determination unit is configured to determine the intersection to be determined by the determination unit based on a vehicle speed of the other vehicle and respective distances from the self-vehicle to the first intersection and the second intersection.

With such a configuration, it is possible to exclude the intersection that is inappropriate as the processing target even when the plurality of other vehicles are present.

The invention is not limited to the foregoing embodiments, and various variations/changes are possible within the spirit of the invention.

What is claimed is:

1. A vehicle control device comprising:
a first acquisition unit configured to acquire information indicating a traveling situation of a self-vehicle;
a first estimation unit configured to estimate a future path of the self-vehicle based on the information indicating the traveling situation of the self-vehicle acquired by the first acquisition unit;
a second acquisition unit configured to acquire information indicating a traveling situation of another vehicle that is different from the self-vehicle;
a second estimation unit configured to estimate a future path of the other vehicle based on the information indicating the traveling situation of the other vehicle acquired by the second acquisition unit;
a determination unit configured to determine whether or not to execute driving support based on a position change of an intersection between the future path of the self-vehicle estimated by the first estimation unit and the future path of the other vehicle estimated by the second estimation unit; and
an execution unit configured to execute the driving support when the determination unit determines to execute the driving support.

2. The vehicle control device according to claim 1, wherein the determination unit is configured to determine whether or not to execute the driving support further based on a first required passing time required for the self-vehicle to pass the intersection and a second required passing time required for the other vehicle to pass the intersection.

3. The vehicle control device according to claim 2, wherein the determination unit is configured to determine to execute the driving support when both the first required passing time and the second required passing time are equal to or less than a threshold.

4. The vehicle control device according to claim 2, wherein the determination unit is configured to determine to execute the driving support when a difference between the first required passing time and the second required passing time is equal to or less than a threshold.

5. The vehicle control device according to claim 1,
wherein, when the information indicating the traveling situation of the self-vehicle indicates a vehicle speed equal to or less than a threshold,
the determination unit is configured to be more likely to determine to execute the driving support when the position of the intersection moves to the self-vehicle side than when the position of the intersection does not move to the self-vehicle side.

6. The vehicle control device according to claim 5,
wherein, when the information indicating the traveling situation of the self-vehicle indicates the vehicle speed equal to or less than the threshold,
the determination unit is configured to be more likely to determine to execute the driving support when a position change of the intersection is a first change amount than when the position change of the intersection is a second change amount smaller than the first change amount.

7. The vehicle control device according to claim 5,
wherein, when the information indicating the traveling situation of the self-vehicle indicates a vehicle speed greater than the threshold,
the determination unit is configured to be less likely to determine to execute the driving support when the position of the intersection moves to the self-vehicle side than when the position of the intersection does not move to the self-vehicle side.

8. The vehicle control device according to claim 7,
wherein, when the information indicating the traveling situation of the self-vehicle indicates the vehicle speed greater than the threshold,
the determination unit is configured to be less likely to determine to execute the driving support when the position change of the intersection is a first change amount than when the position change of the intersection is the second change amount smaller than the first change amount.

9. The vehicle control device according to claim 5, wherein the determination unit is configured to be less likely to determine to execute the driving support when the position of the intersection moves to an opposite side to the self-vehicle side than when the position of the intersection moves to the self-vehicle side.

10. The vehicle control device according to claim 9, further comprising:
an acquisition unit configured to acquire a position of the intersection at a first time and a position of the intersection at a second time after the first time,
wherein a case where the intersection moves to the self-vehicle side is a case where the position of the intersection at the second time is closer to the self-vehicle side than the position of the intersection at the first time.

11. The vehicle control device according to claim 10, wherein a case where the intersection moves to the opposite side to the self-vehicle side is a case where the position of the intersection at the second time is on the opposite side to the self-vehicle side compared to the position of the intersection at the first time.

12. The vehicle control device according to claim 5, wherein the position change of the intersection is a position change within a predetermined distance from the self-vehicle.

13. The vehicle control device according to claim 5,
wherein the determination unit being more likely to determine to execute the driving support includes increasing a threshold of a time required for the self-vehicle to pass the intersection, and
the determination unit being less likely to determine to execute the driving support includes decreasing the threshold.

14. The vehicle control device according to claim 1 further comprising:
a setting unit configured to set priority for a first intersection between the future path of the self-vehicle and a future path of a first other vehicle and a second intersection between the future path of the self-vehicle and a future path of a second other vehicle,
wherein the determination unit is configured to determine whether or not to execute the driving support based on a position change of an intersection having a high priority from between the first intersection and the second intersection.

15. The vehicle control device according to claim 14, wherein the priority is set based on a behavior of the intersection and the required passing time required for the self-vehicle to pass the intersection.

16. The vehicle control device according to claim 1, further comprising an intersection determination unit configured to determine an intersection to be determined by the determination unit from a first intersection between the future path of the self-vehicle and the future path of a first other vehicle and a second intersection between the future path of the self-vehicle and the future path of a second other vehicle.

17. The vehicle control device according to claim 16, wherein the intersection determination unit is configured to determine the intersection to be determined by the determination unit based on a vehicle speed of the other vehicle and respective distances from the self-vehicle to the first intersection and the second intersection.

18. A vehicle control method executed in a vehicle control device, the vehicle control method comprising:
acquiring information indicating a traveling situation of a self-vehicle;
estimating a future path of the self-vehicle based on the acquired information indicating the traveling situation of the self-vehicle;
acquiring information indicating a traveling situation of another vehicle different from the self-vehicle;
estimating a future path of the other vehicle based on the acquired information indicating the traveling situation of the other vehicle;
determining whether or not to execute driving support based on a position change of an intersection between the estimated future path of the self-vehicle and the estimated future path of the other vehicle; and
executing the driving support when it is determined to execute the driving support.

19. A non-transitory computer-readable storage medium storing a program that causes a computer to perform the functions of:
acquiring information indicating a traveling situation of a self-vehicle;
estimating a future path of the self-vehicle based on the information indicating the traveling situation of the self-vehicle;
acquiring information indicating a traveling situation of another vehicle different from the self-vehicle;
estimating a future path of the other vehicle based on the information indicating the traveling situation of the other vehicle;
determining whether or not to execute driving support based on a position change of an intersection between the future path of the self-vehicle and the future path of the other vehicle; and
executing the driving support when it is determined to execute the driving support.
